(19) United States
(12) Patent Application Publication
(10) Pub. No.: US 2023/0163322 A1
(43) Pub. Date: May 25, 2023

(54) BIPOLAR PLATE ASSEMBLY, USE OF A BIPOLAR PLATE ASSEMBLY, AND ELECTROLYSIS OR FUEL CELL STACK COMPRISING A PLURALITY OF BIPOLAR PLATE ASSEMBLIES

(71) Applicant: Forschungszentrum Jülich GmbH, Jülich (DE)

(72) Inventors: Martin MÜLLER, Sinzig (DE); Walter ZWAYGARDT, Jülich (DE); Holger JANSSEN, Jülich (DE); Sebastian HOLTWERTH, Aachen (DE); Wilfried BEHR, Euskirchen (DE); Dirk FEDERMANN, Kevelaer (DE)

(21) Appl. No.: 17/916,118

(22) PCT Filed: Feb. 25, 2021
(86) PCT No.: PCT/EP2021/054724

§ 371 Date: Sep. 30, 2022

(30) Foreign Application Priority Data
Apr. 3, 2020 (DE) 10 2020 109 430.2

(51) Int. Cl. H01M 8/0206; H01M 8/0271; H01M 8/0258; C25B 9/75; C25B 9/77; C25B 11/036; C25B 11/032

(52) U.S. Cl. CPC H01M 8/0206; H01M 8/0271; H01M 8/0258; C25B 9/75; C25B 9/77; C25B 11/036; C25B 11/032; H01M 2004/8694

(57) ABSTRACT

The invention relates to a bipolar plate assembly (1) for forming an electrolysis or fuel cell stack and to the use of a bipolar plate assembly and an electrolysis or fuel cell stack with a plurality of bipolar plate assemblies.

The present invention relates to a bipolar plate assembly for forming an electrolysis or fuel cell stack. Further, the invention relates to the use of such a bipolar plate assembly to form an electrolysis or fuel cell stack and to an electrolysis or fuel cell stack comprising a plurality of such bipolar plate assemblies.

Along with the membrane-electrode-unit, the bipolar plate is the central component in the structure of an electrolysis or fuel cell stack. Both components together constitute the repeating unit. The number of repeating units in a stack determines the power output.

In water electrolysis, the bipolar plate must perform a wide variety of tasks. It introduces the feed water to the respective cell level, distributes the feed water as homogeneously as possible over the cell surface and discharges the mixture of water and hydrogen or oxygen from the cell level. Furthermore, the electric current must be conducted as homogeneously as possible through the bipolar plate. The bipolar plate should have a very high and homogeneous electrical conductivity. In addition, the bipolar plate separates the anode and cathode compartments of two adjacent cells in a gas-tight manner, is gas-tight to the outside (leakage rate <10 exp−6 (mbar l/s) and supports the sealing of the anode and cathode compartments to the outside. Finally, the bipolar plate provides a mechanical and electrical bond to the adjacent membrane-electrode-units.

For the application of a fuel cell, the tasks are known to be similar.

Bipolar plates can essentially be differentiated with regard to the starting material. Bipolar plates made of graphite or graphite/plastic composites and bipolar plates made of metals are known. In order to realize a media distribution over the plate level, known bipolar plates generally contain discrete channels through which the operating materials or fluids are conducted. Mechanical and electrical contacting of the membrane-electrode assembly is then achieved via the webs flanking the flow channels. In particular, the insertion of these flow distribution structures, also known as flowfields, requires special manufacturing processes. In the case of graphite-based bipolar plates, these primarily include injection molding, compression molding and milling. Metallic bipolar plates generally consist of thin foils into which the flow distribution structures are introduced by stamping processes, for example deep drawing. Titanium is often used as the metallic material for electrolysis due to its mechanical properties, corrosion resistance and electrical conductivity, while corrosion-resistant steels can be used for fuel cell applications. In research, flow distributor structures consisting of porous structures are occasionally used for test purposes.

In conventional bipolar plates, the flow distribution structures above the active cell area have a macroscopic structure. Channel and web widths are in the range of 1 mm. The channel lengths are much greater still. Even with interlayers of porous layers in the form of gas diffusion layers, the flow distribution over the active cell area is not homogeneous. This is then accompanied by inhomogeneities in current density and temperature distribution. This in turn can lead to damage due to hot spots or accelerated aging.

Furthermore, discrete channel structures have no flexibility when operating conditions change. The channel height and channel depth are designed for a defined operating point, which is defined, for example, by the volume flow, the temperature and the liquid/gas ratio. As soon as there are deviations from this operating point caused by start-up or shut-down processes, load changes, changes in stoichiometric ratios or the like, these can lead to problems in the uniform distribution and discharge of the fluids. A change in the flow distributor structure is then always associated with a considerable engineering and/or cost effort. New tools have to be provided for manufacturing. In the case of dynamic changes in the flow conditions, even this solution falls away.

Another disadvantage is that the channel/web structure of conventional bipolar plates means that there is no uniform distribution of contact pressure between the bipolar plate and the membrane electrode unit. In the area of the channels, the contact pressure is considerably lower than in the area of the webs. This leads to additional electrical resistances during current introduction or current discharge. In particular, the contact resistance between the cell components involved is increased as a result.

Flow distribution structures with a porous structure use a homogeneous structure with constant porosity, which has the disadvantage that the structure is either too coarse-porous with good macro-distribution but poor micro-distribution or too fine-porous with the opposite effects. Seals for real operation can either not be realized or only with the help of complex plastic frame-seal combinations. These consist of a high number of individual components, which is why a practical cell stack design is not feasible or only with difficulty. A stack design with a very high number of individual components also increases the probability of leaks or other malfunctions. Furthermore, it is not possible to manufacture a bipolar plate with a porous structure for the anode side and the cathode side in one production part. Porous distributor structures are only available as monopolar plates for anode and cathode. Bipolar plates with porous distributor structures, in which the water supply and removal to the cathode and anode can be provided in the cell stack, are not known.

Based on this prior art, it is an object of the present invention to provide an alternative bipolar plate assembly.

To solve this problem, the present invention provides a bipolar plate assembly for forming an electrolysis or fuel cell stack, comprising a metallic separating device adapted to create a fluid-tight seal between the anode side and the cathode side, and provided with fluid supply channels and fluid discharge channels on both the anode and cathode sides, respectively, two metallic flow distributor units arranged adjacent to the at least one separating device on the anode and cathode sides, each flow distributor unit being designed to distribute a fluid supplied to it via the at least one separating device between the fluid supply channels and the fluid discharge channels, and metallic frame members which are connected in a fluid-tight manner to the separating device and which each surround one of the flow distributor units circumferentially in a fluid-tight manner, the frame elements having through-openings which are designed to supply a fluid to the fluid supply channels and through-openings which are designed to discharge via the fluid discharge channels.

The bipolar plate assembly according to the invention is thus composed of several separate components, namely the separating device, the flow distributor units and the frame elements. In the case of water electrolysis, the separating device separates the anode and cathode compartments of two adjacent cells in a gas-tight manner, conducts the electric current homogeneously through it, introduces the feed water to the respective cell level and discharges the mixture of water and hydrogen or oxygen from the cell level. The flow distributor units distribute the feed water supplied via the separating device homogeneously over the cell surface. The frame elements serve to seal the bipolar plate assembly gas-tight to the outside in the area of the distributor structures and establish the mechanical bond to the adjacent membrane-electrode-units. Thanks to the fact that the bipolar plate assembly according to the invention is made of several individual components, the design of the flow distributor units in particular can be selected very freely, so that desired flow fields can be adjusted very well within a cell. In addition, with a suitable choice, proper functioning of a cell can be ensured even if deviations from the operating point for which it is designed occur during operation. Due to the fact that all components are made of metallic materials, they can be easily joined to form a one-piece bipolar plate assembly using suitable joining processes. One possible joining process is diffusion welding, for example. In this process, all components of the bipolar plate assembly are placed on top of each other according to the intended structure and introduced into a heatable vacuum furnace. In addition, the furnace contains a pressing device that can be moved via force and path control. The bipolar plate components are welded together at the contact points by a suitable combination of process atmosphere, if necessary inert gas (usually vacuum <10 exp−4 mbar), vacuum, temperature, pressing force and process time. The process parameters to be set essentially depend on the materials of the individual components and their size and design.

Preferably, the separating device and the frame elements each have a rectangular outer circumference, the outer circumferences being designed in particular to be congruent. Accordingly, the separating device and frame elements can simply be placed on top of each other and joined in a gas-tight manner.

An embodiment of the present invention is characterized in that all through-openings of one frame element are positioned in alignment with the through-openings of the other frame element, and in that the separating device is provided with through-holes positioned in alignment with the through-openings of the frame elements and connecting them with the fluid supply channels and fluid discharge channels of the separating device. In this way, a simple and inexpensive structure is created by means of which the supply and discharge of fluids are realized via the separating device and the two frame elements.

Advantageously, the anode-side fluid supply channels and the anode-side fluid discharge channels are arranged opposite one another, in that the cathode-side fluid supply channels and the cathode-side fluid discharge channels are arranged opposite one another, and in that the anode-side fluid supply channels and the cathode-side fluid supply channels are arranged offset by 90° with respect to one another. In this way, the electrochemical cell is operated in cross-flow.

Preferably, the fluid supply channels and the fluid discharge channels are provided in the form of grooves formed on the anode-side and cathode-side surfaces of the separating device and extending inwardly from the through holes. This results in a simple and inexpensive structure to manufacture. Each through-hole can be assigned a single groove or a plurality of grooves arranged, for example, like a beam.

According to a variant of the present invention, the separating device consists of a single separating device plate, which is then provided with the fluid supply channels and the fluid discharge channels on its anode-side and cathode-side surfaces.

Alternatively, it is also possible for the separating device to have two separating plates which are firmly connected to one another, in particular soldered or welded to one another. This can be advantageous from a manufacturing point of view, since only one side of each separating device plate has to be provided with fluid supply and fluid discharge channels, which then forms the anode side or the cathode side of the separating device.

Advantageously, the flow distributor units are made of layers having recurring passages, in particular of layers in the form of expanded metals, fabrics and/or nonwovens. Compared with channel structures, layers with recurring passages of this kind have the advantage that the size of the passages can be selected more freely and can therefore be better adapted to operating conditions. On the other hand, the contact pressure distribution between the flow distributor units and the membrane-electrode-units can be significantly reduced and made much more uniform, which is associated with lower electrical resistances during current introduction in the case of an electrolysis cell or current discharge in the case of a fuel cell. Furthermore, the flow field can be influenced in a targeted manner by combining several superimposed layers, which may have different designs.

Preferably, the size of the passages of at least one flow distributor unit, in particular of both flow distributor units, increases in the direction of the separating device. Larger passages and a correspondingly coarser structure provide a coarse flow distribution with low pressure loss over the entire associated area of the flow distributor unit. Smaller passages and a correspondingly finer structure distribute the flow more evenly over the active cell area and reduce the local mechanical stress on the membrane-electrode-unit.

The separating device and/or at least one of the flow distributor units and/or the frame elements are advantageously made of a corrosion-resistant metal or are provided with a corrosion-resistant metal coating. Here, for example, the use of titanium as a corrosion-resistant metal or as a corrosion-resistant metal coating is suitable.

Advantageously, the separating device, the flow distributor units and the frame elements are soldered or welded together, with the use of a diffusion welding process being preferred, whereby a one-piece structure can be achieved in a simple manner while achieving a gas-tight connection of the separating device and the frame elements. With one-piece bipolar plates, electrolysis or fuel cell stacks can be assembled much more easily due to the greatly reduced number of individual parts. Another advantage that comes into play with a thermally joined bipolar plate assembly is that, according to the invention, the fluid supply channels and the fluid discharge channels are provided on the separating device accommodated between the two frame elements and thus inside the bipolar plate assembly, so that the fluid supply channels and the fluid discharge channels cannot have a negative effect on the contact pressure distribution when bipolar plate assemblies according to the invention are connected to membrane electrode units. Another advantage of the materially joined bipolar plate assembly is that there are no (or greatly reduced) contact or transition resistances between the components of the bipolar plate assembly. These resistances are present in superimposed and braced elements as a function of the contact force and lead to a reduction in efficiency.

Advantageously, a metallic gas diffusion layer is attached from the outside to one of the flow distributor units, in particular by means of soldering or welding, preferably to the flow distributor unit arranged on the anode side.

Furthermore, the invention proposes to use a bipolar plate assembly according to the invention to form an electrolysis or fuel cell stack.

In addition, the present invention creates an electrolysis or fuel cell stack comprising a plurality of bipolar plate assemblies according to the invention to solve the above problem.

Further advantages and features of the present invention will become apparent from the following description of a bipolar plate assembly according to one embodiment of the present invention, with reference to the accompanying drawing. Therein is

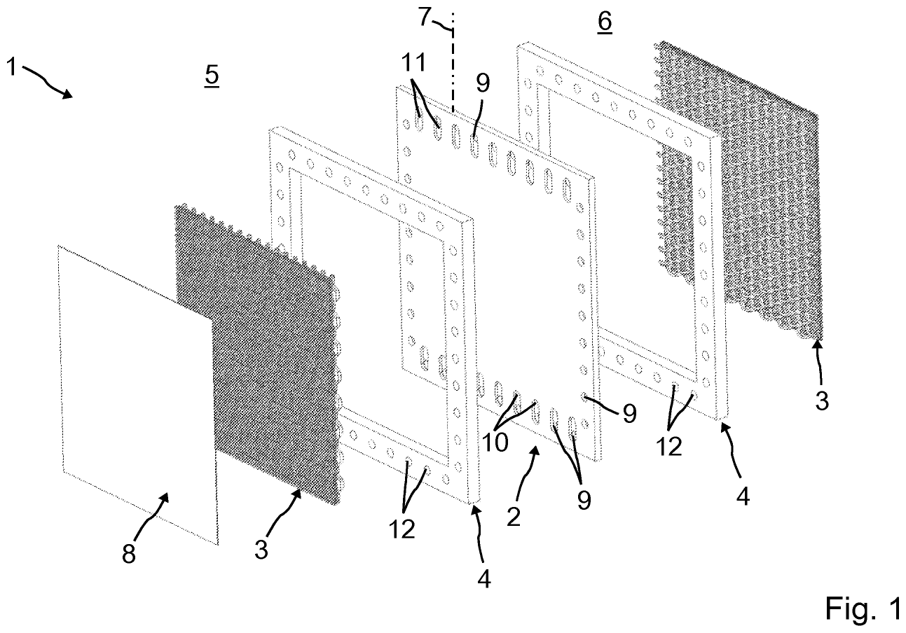

FIG. 1 a perspective exploded view of a bipolar plate assembly according to one embodiment of the present invention;

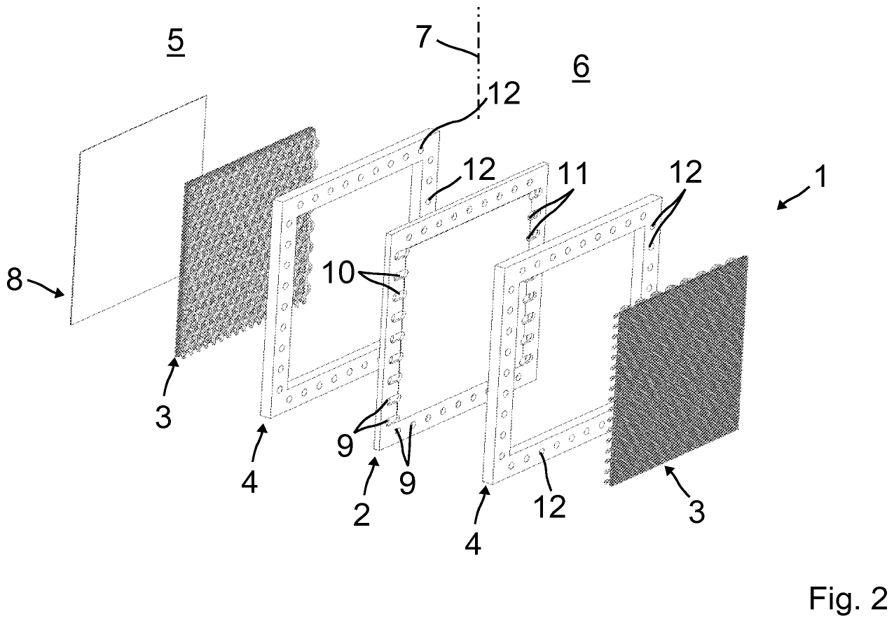

FIG. 2 another perspective exploded view of the bipolar plate assembly;

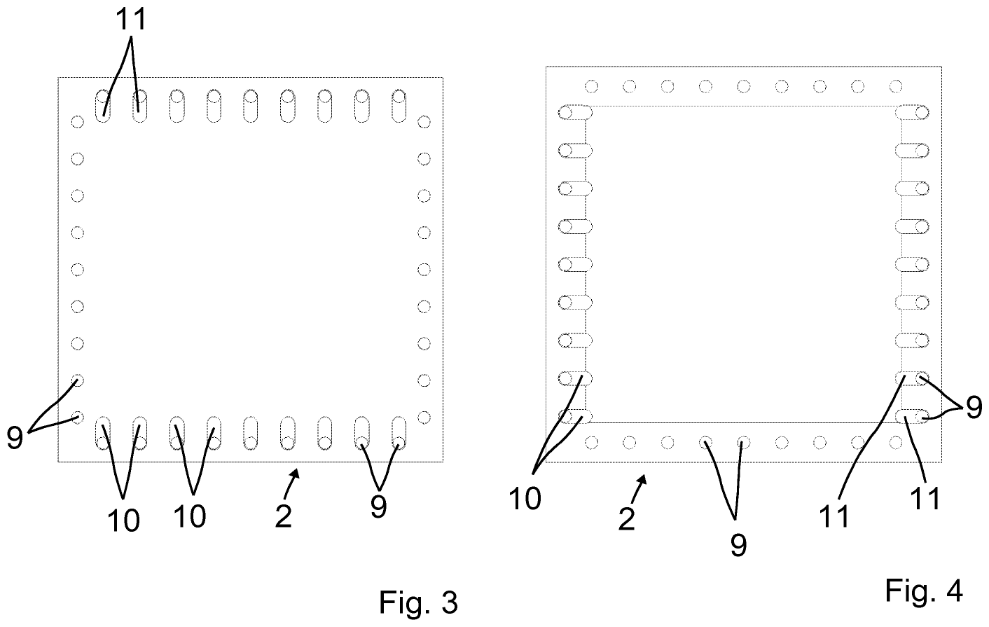

FIG. 3 a cathode side view of a separation device of the bipolar plate assembly;

FIG. 4 an anode-side view of the separating device;

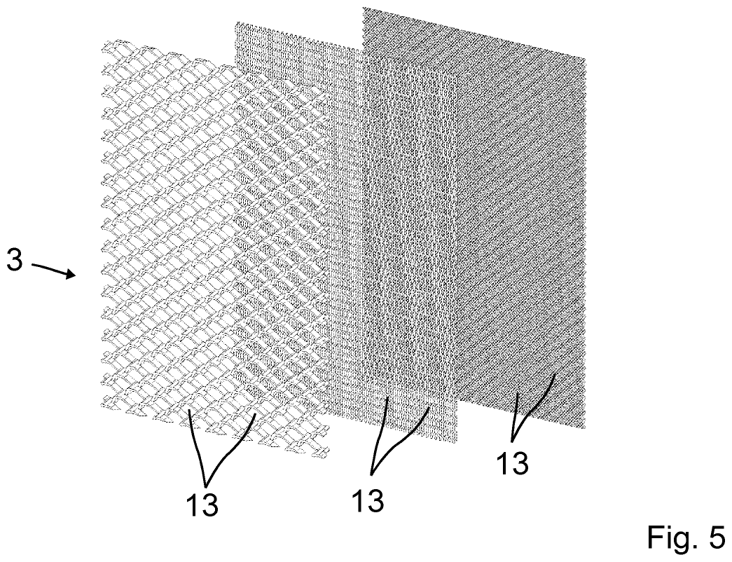

FIG. 5 a perspective exploded view of a cathode-side flow distribution unit shown in FIG. 1;

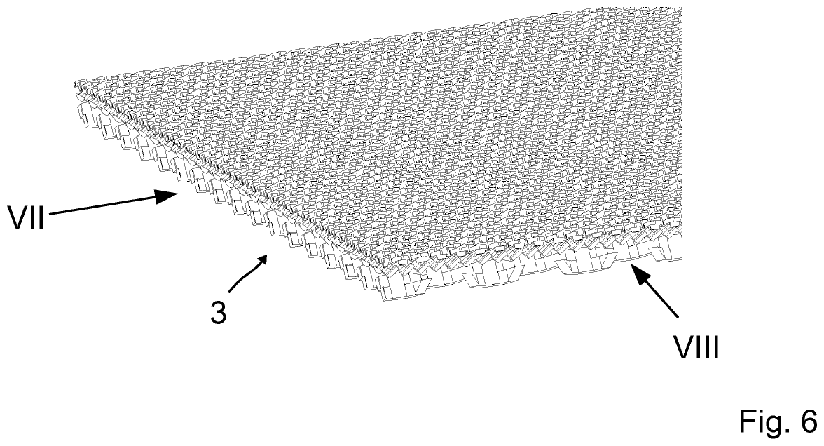

FIG. 6 a partial perspective view of the flow distributor unit in the assembled state;

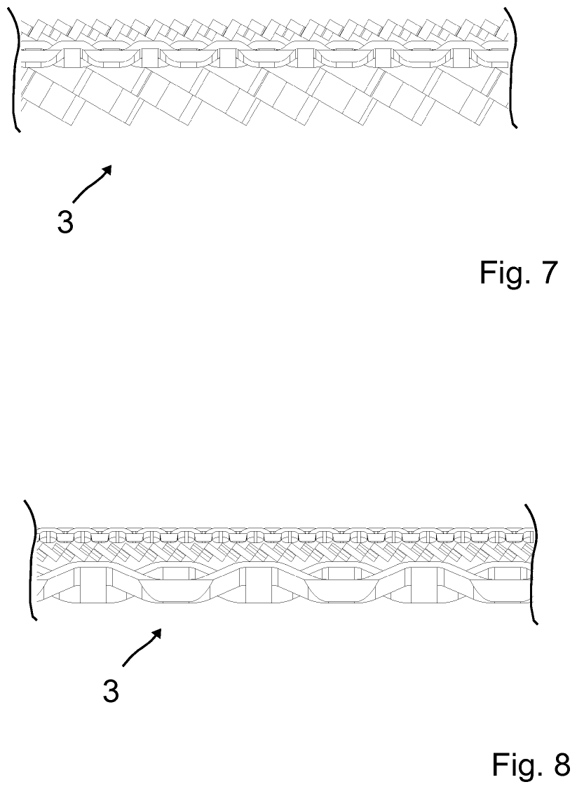

FIG. 7 a partial side view of the flow distribution unit in the direction of arrow VII in FIG. 6;

FIG. 8 a partial side view of the flow distribution unit in the direction of arrow VIII in FIG. 6;

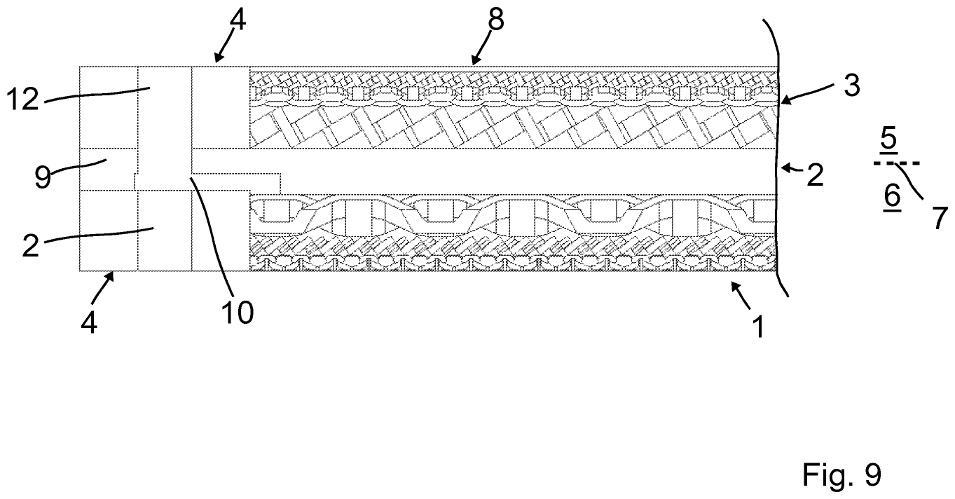

FIG. 9 a sectional view of a portion of the assembled bipolar plate and

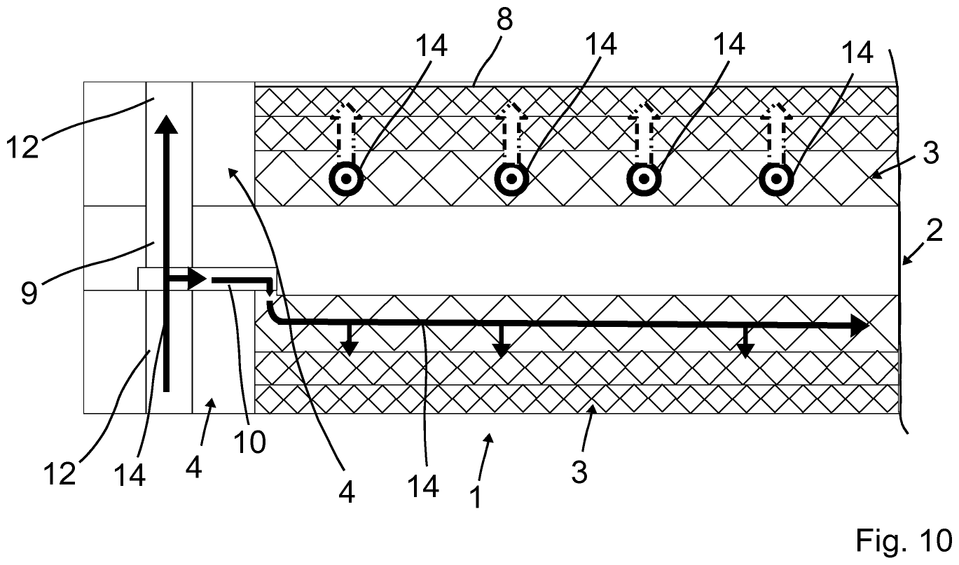

FIG. 10 a sectional view of a portion of the assembled bipolar plate as in FIG. 9 with flow drawn through.

FIGS. 1, 2 and 9 show a bipolar plate assembly 1 according to one embodiment of the present invention, which has as main components a substantially centrally arranged metallic separating device 2, two metallic flow distributor units 3, which are each arranged adjacent to the separating device 2, and two metallic frame elements 4, which each surround the flow distributor units 3 in a circumferentially gas-tight manner in the assembled state of the bipolar plate assembly 1. The separating device 2 separates the bipolar plate assembly 1 into an anode side 5 and a cathode side 6, the separation being symbolized by a dashed line 7 in FIGS. 1, 2 and 9 respectively. The anode side 5 is located on the left in FIGS. 1 and 2 in each case and above the dashed line 7 in FIG. 9, the cathode side 6 is located on the right in FIGS. 1 and 2 and below the dashed line 7 in FIG. 9. As a further main component, a metallic gas diffusion layer 8 covering the outward-facing surface of the flow distributor unit 3 is provided on the anode side, but is in principle optional and can also represent a component of an associated-membrane-electrode unit.

The metallic separating device 2 is designed to create a fluid-tight seal between the anode side 5 and the cathode side 6. In the present case, it consists of a single separating plate in the form of a metal sheet. In principle, however, it is also possible to form the separating device 2 from two separating device plates which are then firmly connected to one another, for example by means of soldering or welding. The separating device 2 has a rectangular, in the present case square, outer circumference and is provided along its plate edges with through-holes 9, which are preferably arranged at regular intervals from one another. On two opposite plate edges of one plate side, for example on the plate side facing the anode side 5, additional groove-like channels or blind holes extending inwards in the direction of the plate center are provided starting from the through-holes 9, the channels extending along one plate edge forming fluid supply channels 10 and the channels extending along the opposite plate edge forming fluid discharge channels 11. The depth of the fluid supply channels 10 and fluid discharge channels 11 is in each case less than the plate thickness. On the other side of the plate, these additional channels forming fluid supply channels 10 and fluid discharge channels 11 are also provided, but at those through-holes 9 which extend along the plate edges offset by 90°. Thus, there is never another fluid supply channel 10 or fluid discharge channel 11 on the rear side of a fluid supply channel 10 or fluid discharge channel 11.

The metallic frame elements 4 are likewise square in shape, analogously to the separating device 2, the outer circumference of the frame elements 4 each being adapted to the outer circumference of the separating device 2. Each frame element 4 is provided along its side edges with through-openings 12, the number and position of which correspond to the number and position of the through-holes 9 of the separating device 2, so that the through-openings 12 of the frame elements 4 and the through-holes 9 of the separating device 2 are aligned with each other as soon as the frame elements 4 are placed on both sides of the separating device 2 in the intended manner.

The metallic flow distributor units 3 are each formed by a composite of expanded metals, although metallic fabrics, nonwovens or the like can also be used in principle. The expanded metals used each have passages 13 of different sizes and thus different porosities. In the embodiment shown, an expanded metal combination of three different expanded metals is selected. A coarse expanded metal, which is arranged facing the separating device in each case, provides the coarse flow distribution and mechanical support. The medium and fine expanded metal are used to distribute the contact force and flow to the active cell surface. The materials of the flow distribution units 3 are precisely inserted into the inner circumference of the frame elements 4. The structure of the materials for flow distribution on the anode side 5 and cathode side 6 may well be different. In the present case, the expanded metal composite is also rotated 90° to each other for the anode and cathode. The thicknesses of the materials and the associated frame elements 4 are matched to each other, taking into account the subsequent joining process.

All components are made of titanium, although other metallic materials that meet the subsequent requirements, in particular with regard to corrosion resistance, can also be used.

To assemble the bipolar plate assembly 1, the individual components are preferably joined using a thermal joining process, in this case using a diffusion bonding process. All components of the bipolar plate assembly 1 are placed on top of each other according to the intended structure and placed in a heatable vacuum furnace. In addition, the furnace contains a pressing device that can be moved by force and path control. The bipolar plate components are welded together at the contact points by a suitable combination of process atmosphere, if necessary inert gas (usually vacuum <10 exp−4 mbar), vacuum, temperature, pressing force and process time. The process parameters to be set essentially depend on the materials of the individual components and their size and design.

In the electrolysis or fuel cell stack, the bipolar plate assembly 1 forms a repeating unit, as does the membrane electrode unit. To produce an electrolysis or fuel cell stack, the repeating units are stacked accordingly and connected to each other in a manner known in and of itself, for example by using end plates and clamping elements pressed onto each other. Fluid or media is supplied or removed separately for the anode and cathode compartments. Each row of holes extending along a side edge of the assembled electrolytic or fuel cell stack, consisting of through holes 9, through openings 12 and fluid supply or fluid discharge channels 10, 11, represents the fluid supply or fluid discharge for the anode side 5 and cathode side 6, respectively. Supply and discharge always take place via opposite rows of holes. Thus, the connections for the anode compartments are rotated 90° to the connections for the cathode compartments. A cross-flow configuration is formed with respect to the fluids in the anode and cathode compartments. Typically, the fluids are connected to the electrolysis or fuel cell stack by means of a conduit. In this case, an elongated manifold, not shown in detail here, is still to be provided outside or inside the stack to distribute the supplied fluid from the conduit to the individual rows of holes. When fluid is supplied via a row of holes, there is a division into two partial flows when flowing through a bipolar plate assembly 1. The flow through the cross-section of the bipolar plate assembly is indicated in FIG. 10 by corresponding arrows 14. This division is determined by the assembly of the fluid supply channels 10 and the fluid discharge channels 11 of the separating device 2. The partial flow diverted in these channels has access to the flow distribution units 3 and is introduced into the coarse expanded metal from below. This is made possible by the fact that the fluid supply channels 10 extend further into the interior of the plate than the frame elements 4. The outflow of the fluids takes place correspondingly through the opposite fluid discharge channels 11. By rotating the fluid supply channels 10 and fluid discharge channels 11 on the anode side 5 and the cathode side 6 by 90°, the electrochemical cell is operated in cross-flow.

### LIST OF REFERENCE SIGNS

1 bipolar plate assembly
2 separating device
3 flow distributor unit
4 frame element
5 anode side
6 cathode side
7 dashed line
8 gas diffusion layer
9 through-hole
10 fluid supply channel
11 fluid discharge channel
12 through-opening
13 passage
14 arrows

1. Bipolar plate assembly (1) for forming an electrolysis or fuel cell stack, comprising
a metallic separating device (2) adapted to create a fluid-tight seal between the anode side (5) and the cathode side (6), and provided with fluid supply channels (10) and fluid discharge channels (11) on both the anode and cathode sides, respectively,
two metallic flow distributor units (3) arranged adjacent to the separating device (2) on the anode and cathode sides, each flow distributor unit (3) being designed to distribute a fluid supplied to it via the separating device (2) between the fluid supply channels (10) and the fluid discharge channels (11), and
metallic frame elements (4) which are connected in a fluid-tight manner to the separating device (2) and which each surround one of the flow distributor units (3) circumferentially in a fluid-tight manner, the frame elements (4) having through-openings (12) which are designed to supply a fluid to the fluid supply channels (10) and through-openings (12) which are designed to discharge a fluid discharged via the fluid discharge channels (11).

2. Bipolar plate assembly (1) according to claim 1, wherein the separating device (2) and the frame elements (4) each have a rectangular outer circumference, the outer circumferences being designed in particular to be congruent.

3. Bipolar plate assembly (1) according to claim 1, wherein all through-openings (12) of one frame element (4) are positioned in alignment with the through-openings (12) of the other frame element (4), and wherein the separating device (2) is provided with through-holes (9) positioned in alignment with the through-openings (12) of the frame elements (4) and connecting them with the fluid supply channels (10) and fluid discharge channels (11) of the separating device (2)

4. Bipolar plate assembly (1) according to claim 1, wherein the anode-side fluid supply channels (10) and the anode-side fluid discharge channels (11) are arranged opposite one another, wherein the cathode-side fluid supply channels (10) and the cathode-side fluid discharge channels (11) are arranged opposite one another, and wherein the anode-side fluid supply channels (10) and the cathode-side fluid supply channels (10) are arranged offset by 90° with respect to one another.

5. Bipolar plate assembly (1) according to claim 4, wherein the fluid supply channels (10) and the fluid discharge channels (11) are provided in the form of grooves formed on the anode-side and cathode-side surfaces of the separating device (2) and extending inwardly from the through holes (9).

6. Bipolar plate assembly (1) according to claim 1, wherein the separating device (2) consists of a single separating plate.

7. Bipolar plate assembly (1) according to claim 1, wherein the separating device (2) has two separating plates which are firmly connected to one another, in particular soldered or welded to one another.

8. Bipolar plate assembly (1) according to claim 1, wherein the flow distributor units (3) are made of layers having recurring passages, in particular of layers in the form of expanded metals, fabrics and/or nonwovens.

9. Bipolar plate assembly (1) according to claim 8, wherein the size of the passages of at least one flow distributor unit (3), in particular of both flow distributor units (3), increases in the direction of the separating device (2).

10. Bipolar plate assembly (1) according to claim 1, wherein the separating device (2) and/or at least one of the flow distributor units (3) and/or the frame elements (4) are made of a corrosion-resistant metal or are provided with a corrosion-resistant metal coating.

11. Bipolar plate assembly (1) according to claim 1, wherein the separating device (2), the flow distributor units (3) and the frame elements (4) are soldered or welded together.

12. Bipolar plate assembly (1) according to claim 1, wherein a metallic gas diffusion layer (8) is attached from the outside to one of the flow distributor units (3), in particular by means of soldering or welding, preferably to the flow distributor unit (3) arranged on the anode side.

13. Use of a bipolar plate assembly (1) according to claim 1 to form an electrolysis or fuel cell stack.

14. Electrolysis or fuel cell stack comprising a plurality of bipolar plate assemblies (1) according to claim 1.

15. Bipolar plate assembly (1) according to claim 2, wherein all through-openings (12) of one frame element (4) are positioned in alignment with the through-openings (12) of the other frame element (4), and wherein the separating device (2) is provided with through-holes (9) positioned in alignment with the through-openings (12) of the frame elements (4) and connecting them with the fluid supply channels (10) and fluid discharge channels (11) of the separating device (2)

16. Bipolar plate assembly (1) according to claim 2, wherein the anode-side fluid supply channels (10) and the anode-side fluid discharge channels (11) are arranged opposite one another, wherein the cathode-side fluid supply channels (10) and the cathode-side fluid discharge channels (11) are arranged opposite one another, and wherein the anode-side fluid supply channels (10) and the cathode-side fluid supply channels (10) are arranged offset by 90° with respect to one another.

17. Bipolar plate assembly (1) according to claim 3, wherein the anode-side fluid supply channels (10) and the anode-side fluid discharge channels (11) are arranged opposite one another, wherein the cathode-side fluid supply channels (10) and the cathode-side fluid discharge channels (11) are arranged opposite one another, and wherein the anode-side fluid supply channels (10) and the cathode-side fluid supply channels (10) are arranged offset by 90° with respect to one another.
